(19) United States
(12) Patent Application Publication
(10) Pub. No.: US 2025/0139411 A1
(43) Pub. Date: May 1, 2025

(54) SYSTEMS AND METHODS FOR ARTIFICIAL INTELLIGENCE AGENTS

(71) Applicant: Salesforce, Inc., San Francisco, CA (US)

(72) Inventors: Rithesh Murthy, San Francisco, CA (US); Shelby Heinecke, San Francisco, CA (US); Juan Carlos Niebles Duque, Mountain View, CA (US); Zhiwei Liu, Palo Alto, CA (US); Le Xue, Mountain View, CA (US); Weiran Yao, San Francisco, CA (US); Yihao Feng, Austin, TX (US); Zeyuan Chen, Mountain View, CA (US); Akash Gokul, San Francisco, CA (US); Devansh Arpit, Pacifica, CA (US); Ran Xu, Mountain View, CA (US); Lik Mui, San Francisco, CA (US); Huan Wang, Palo Alto, CA (US); Caiming Xiong, Menlo Park, CA (US); Silvio Savarese, Palo Alto, CA (US)

(21) Appl. No.: 18/498,229

(22) Filed: Oct. 31, 2023

(51) Int. Cl. G06N 3/0455; G06N 3/084

(52) U.S. Cl. CPC G06N 3/0455; G06N 3/084

(57) ABSTRACT

Embodiments described herein provide a large language model (LLM) based AI agent that adopts Monte-Carlo Tree Search (MCTS) to execute a task. The LLM is prompted with a task description and it responds with its first attempted list of actions. Based on the success or failure of the first attempt, the LLM is prompted with an updated prompt which includes feedback from the first attempt based on a determined reward. The prompt may include a relative “score” for each action taken at each step. A numeric score may be mapped to a set of pre-defined text labels, such as “high” or “low” value putting the score in a form more suited for an LLM prompt. In this way, the LLM is iteratively given prompts which are updated with the scores from each action taken at each previous iterations so that it traverses different paths on the tree in each iteration.

### TECHNICAL FIELD

The embodiments relate generally to machine learning systems for artificial intelligence (AI) agents, and more specifically to employing AI agents for acting on an environment.

### BACKGROUND

Traditionally, expensive labor and time is used to assist different needs of a user and/or customer, such as customer service, assisted shopping, and/or the like. Some machine learning systems have been used in deploying AI agents to perform tasks including actions performed on an environment (e.g., a shopping website, a customer service tool, and/or the like) through the use of AI agents. However, such AI agents largely lack efficiency and are unable to perform a destined task desired by a user.

### BRIEF DESCRIPTION OF THE DRAWINGS

FIG. 1 is a simplified diagram illustrating an AI agent framework according to some embodiments.

FIG. 2A is a simplified diagram illustrating a Monte-Carlo Tree Search framework according to some embodiments.

FIG. 2B is a simplified diagram illustrating a Monte-Carlo Tree Search framework according to some embodiments.

FIG. 2C is a simplified diagram illustrating a Monte-Carlo Tree Search framework according to some embodiments.

FIG. 2D is a simplified diagram illustrating tree searching within an AI agent framework according to some embodiments.

FIG. 3 is a simplified diagram illustrating an AI agent framework according to some embodiments.

FIG. 4A is a simplified diagram illustrating a computing device implementing the AI agent framework described in FIGS. 1-3, according to some embodiments.

FIG. 4B is a simplified diagram illustrating a neural network structure, according to some embodiments.

FIG. 5 is a simplified block diagram of a networked system suitable for implementing the AI Agent framework described in FIGS. 1-3 and other embodiments described herein.

FIG. 6 is an example logic flow diagram illustrating a method of predicting a sequence of actions by a neural network based language model based on the framework shown in FIGS. 1-3, according to some embodiments.

FIGS. 7-10 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### Overview

An AI agent may be deployed to perform a task while interacting with one or more users. For example, an agent presented with the task of “purchase a guitar on the Amazon website” may perform a series of steps interacting with Amazon with the goal of purchasing a guitar. Existing AI gents often inefficiently search the entire space of possible actions for every single action at a time. Such search process may decompose the target task into a series of single actions over multiple timesteps, but each timestep requires a separate prompt for the AI agent to perform each action

For example, in response to a target task of “purchase a guitar on the Amazon website,” the AI agent may first identify available options on Amazon, using a prompt such as “sending a search query of electric guitar on Amazon.com”; then receive and sort through the received options, using another prompt such as “ranking the search results based on search price,” and on. The search computations may consume significant power and computational resources.

In view of the need for improved efficiency in operating AI agents for performing a task, embodiments described herein provide systems and methods for rapid exploration and exploitation of a space of possible actions to determine an action to be performed by an AI agent in response to an ongoing interactive session between the AI agent and a user. In one embodiment, for example, a Monte Carlo Tree Search (MCTS) which traverses a tree of possible actions may be performed. For example, a task instruction may by “buy a guitar on Amazon” and the actions may include “enter ‘amazon.com’ into the URL”, “click the search button”, “click the first result”, “click add to cart”, “click check out”, etc. The balance between exploration and exploitation in searching the action space may be controlled by a score associated with each action which may be determined based on the success or failure of a prior attempt.

Embodiments provide a Large language model (LLM) based AI agent that adopts MCTS to execute a task by searching and performing one or more actions in the space of possible actions. In one embodiment, the LLM may receive an input prompt based on a task description and may in turn generate a first attempted list of actions corresponding to the specific task. The AI agent may then carry out the first attempted list of actions to achieve a result towards completing the target task. Actions may be performed, for example, by a processor interacting with an application programming interface (API), a web browser, or some other interface. In some embodiments, actions may be performed on a simulated environment. For example, it would not be desirable to purchase items on Amazon until the agent achieves the correct result, so first attempts may be performed on a simulated website until a successful result is achieved.

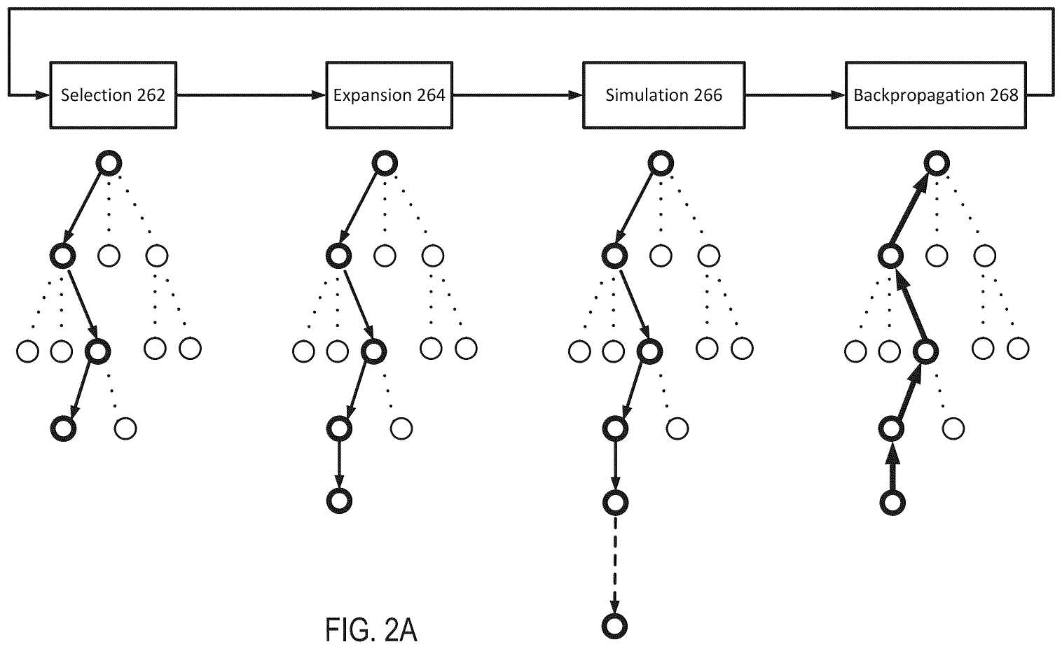

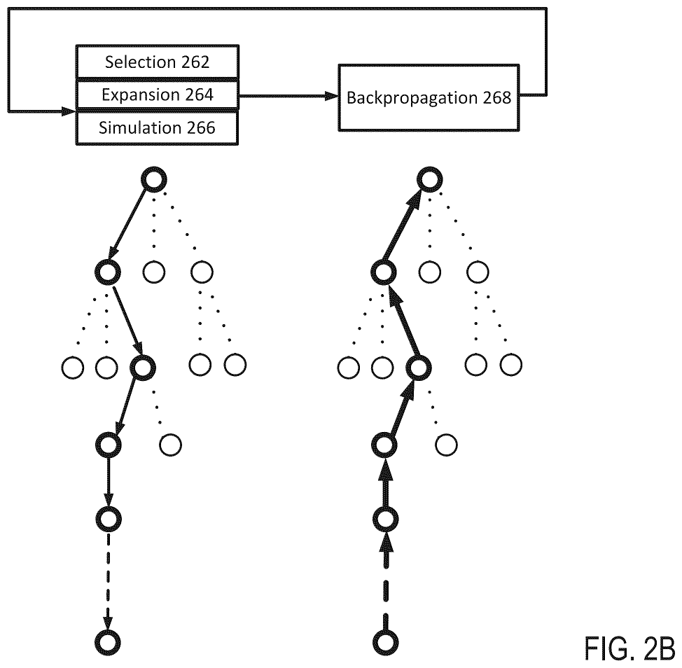

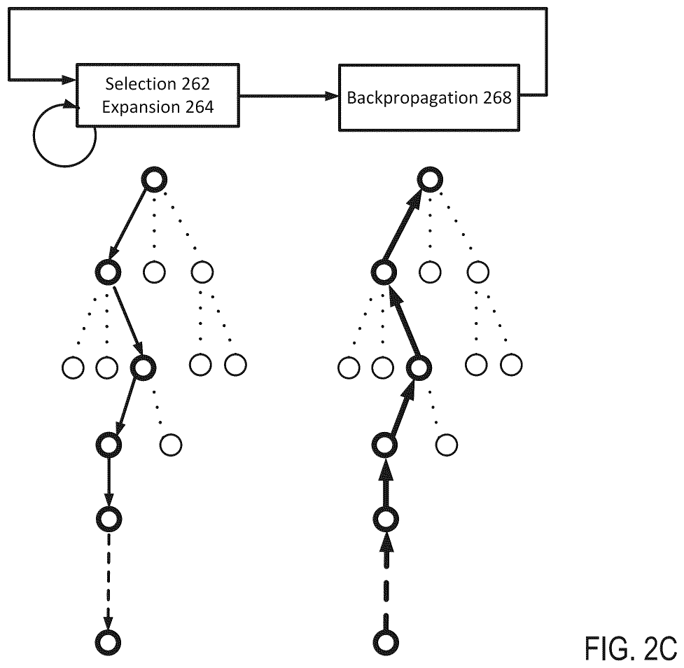

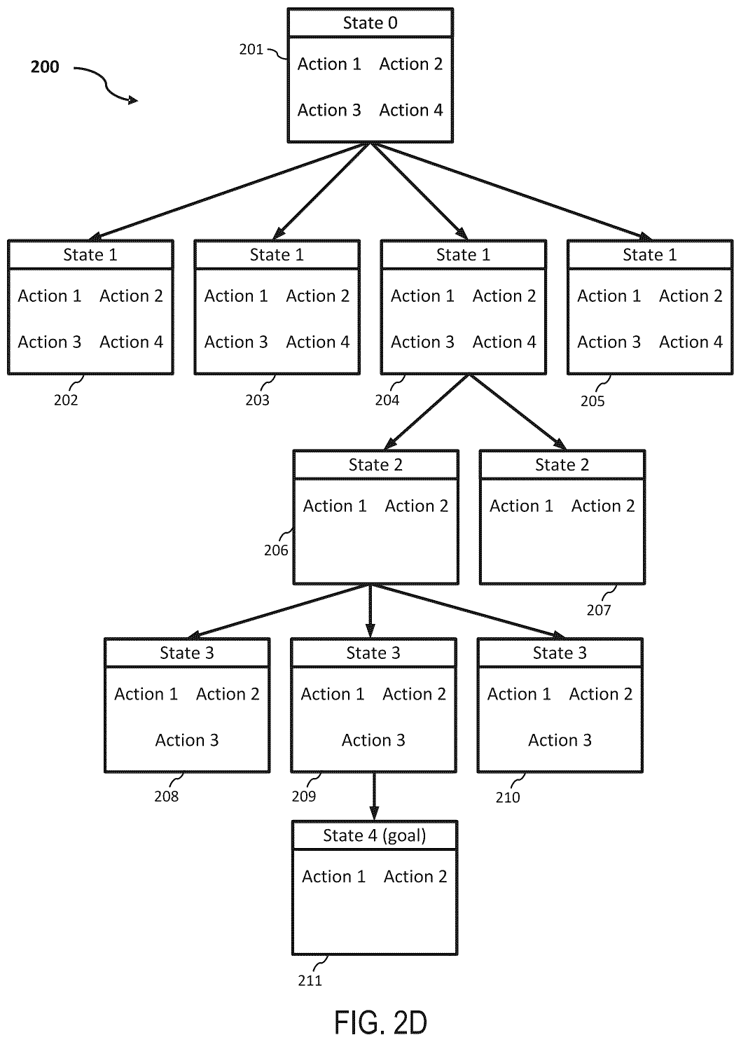

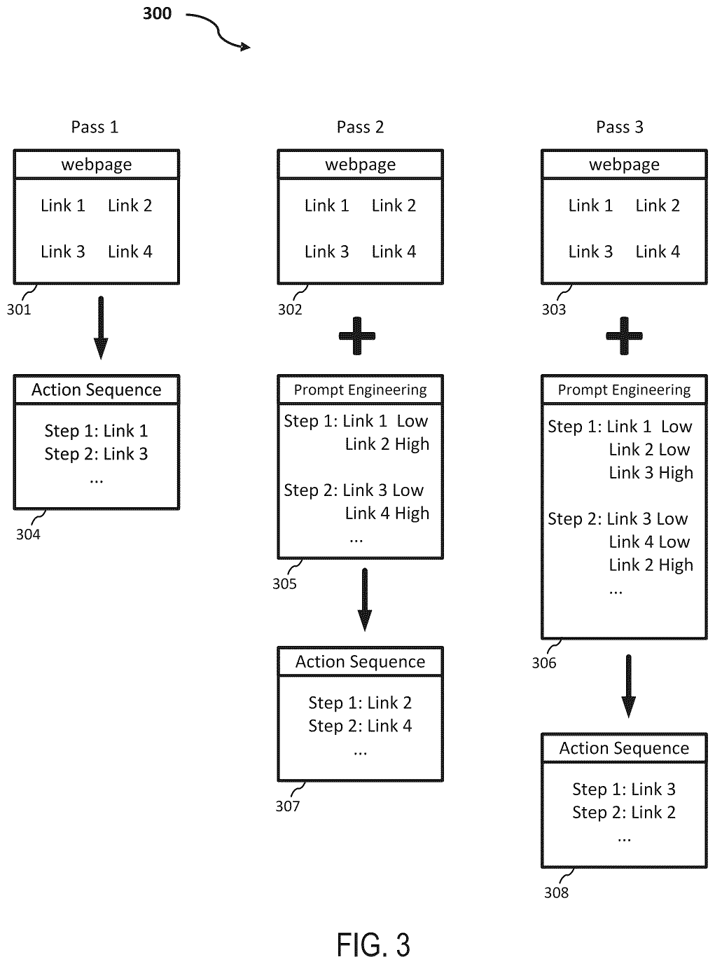

In at least one embodiment, based on the success or failure of performing the first attempted list of actions to complete the target task, the prompt for the LLM may be updated to include feedback from the first attempt. In at least one embodiment, success or failure is determined by an LLM with an input of a prompt asking if the selected actions would result in a correct response from the environment. LLM validation may also be based on a response from the environment or a simulated environment. In at least one embodiment, success or failure is determined by human annotation. In at least one embodiment, the prompt for the LLM may be updated with comprise a reward determined by the LLM or another language model for each action taken. Specifically, a numeric “score” for each action from the first attempted list may be computed (e.g., by a processor), which may then be mapped to a set of pre-defined text labels, such as “high” or “low” value. For example, the numeric score may be an upper confidence bound (UCB) score. Such text labels may be included into the text prompt for the LLM. In this way, the LLM may constantly and/or iteratively generate an updated attempted of actions for completing a target task based on prompts which are iteratively updated using the scores from actions taken at a prior step, so that it traverse different paths on the tree in each iteration (e.g., as described in FIGS. 2-3).

Embodiments described herein provide a number of benefits. For example, by generating an entire sequence of actions to be performed in order to complete a target task based on a single prompt, rather than separately generating each individual action using an input of separate prompt, the AI agent may execute a possible path/sequence of actions that may possibly complete the target task and then evaluate whether the possible path leads to success or failure more efficiently. By mapping numeric scores to text-based labels, the scores are more accurately utilized by the LLM-based agent. Further, specific methods of determining scores for each action described herein optimize the balancing of exploration (i.e., breadth) and exploitation (i.e., depth) of a search tree, thereby arriving at an optimal solution in less time and/or with fewer computing resources. Therefore, the AI agent may execute a target task with improved efficiency and overall accuracy. Neural network technology in AI agents is thus improved.

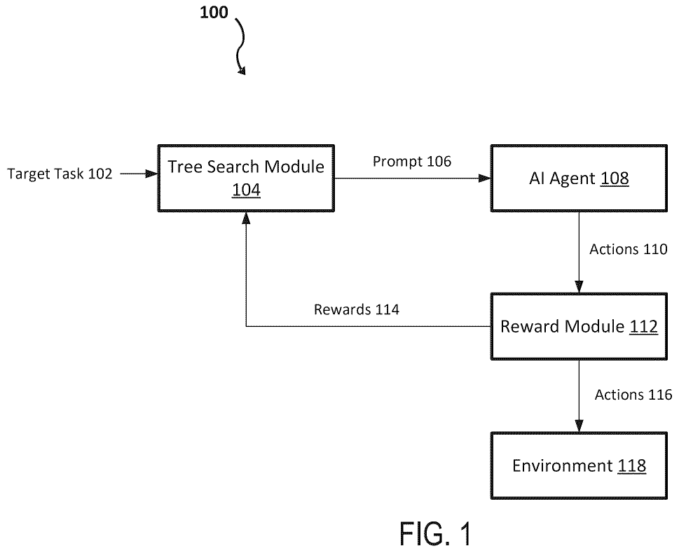

FIG. 1 is a simplified diagram illustrating an AI agent framework 100 according to some embodiments. Framework 100 iteratively utilizes an AI agent 108 to determine and refine a sequence of actions to perform on an environment in order to accomplish a target task. Specifically, framework 100 comprises a tree search module 104 which may store in memory a representation of a tree structure including possible actions which may be taken for each step in performing a task. Tree search module 104 receives a target task 102 which may be a natural language prompt (e.g., “buy an electric guitar online”). The target task 102 may include a predetermined prompt portion, and a user-defined portion. For example, the predetermined portion may describe the type of response expected from the language model, the format expected of the response, etc., and the user-defined portion may be the substantive task desired to be completed. Tree search module 104 may have predetermined possible actions, may determine possible actions by observing an environment (e.g., environment 118), or may begin with an empty set of actions which is populated as AI agent 108 determines actions. Using information regarding existing possible actions, tree search module 104 constructs a prompt 106 which is an input to AI agent 108. AI agent 108 may be a neural network based language model such as a “large language model” (LLM).

Based on a prompt 106, AI agent 108 may generate a sequence of actions 110 to be performed on an environment (e.g., environment 118). In some embodiments, actions 110 are caused to be performed on environment 118. In some embodiments, a second environment which may be a simulated environment may be used for some or all iterations of actions 110. In some embodiments, actions 110 may by performed on environment 118 only after multiple iterations, and in the prior iterations the performance of actions 110 is predicted by a neural network based model. For example, AI agent 108 itself may self-validate the correctness of actions 110 via a second prompt which prompts the AI agent to determine if actions 110 would be successful.

Reward module 112 determines a reward associated with each set of actions 110. Reward module 112 may determine if an attempted list of actions 110 are successful (e.g., whether the target task of “buying an electric guitar online” has been completed) by a number of methods including prompting a language model to predict whether they would succeed, performing actions 110 on a simulated environment, and/or performing actions 110 on an actual environment. For example, a simulated environment may include a simulation of an e-commerce website which allows framework 100 to simulate purchasing an item without actually purchasing an item, so that different actions may be tested without unwanted consequences. Reward module 112 may determine individual reward scores for each action of actions 110 based on whether that action was in a set of actions 110 which produced a desired result, and further based on the number of times that action was attempted.

For example, an upper confidence bound (UCB) type score may be determined. In some embodiments, a reward score may be determined by:

$$UCB ( s , a ) = \hat{Q} ( s , a ) + C * \sqrt{\frac{ln N}{N ( s , a )}}$$

where “s” represents the state of the environment 118, “a” represents the action taken at state s, N is the number of times state s was produced as part of a solution, N(s,a) is the number of times AI agent 108 took an action a from state s, C is a constant which controls the balance between exploitation and exploration of the action sequence tree, and \hat{Q}(s,a) is the cumulative reward for taking action a at state s.

An equation such as the one described above may be used to produce a numeric reward score associated with each action. Computed rewards 114 may be used by tree search module 104 to update the rewards in memory associated with each action. The updated rewards may be used to inform how to generate the next prompt 106 (for example as described with respect to FIG. 2D). After a number of iterations, which may be a predetermined/configurable number of iterations or after finding a successful solution, actions 116 (i.e., the verified actions 110) may be executed on environment 118. In some embodiments, actions 116 is the set of actions which achieved the highest cumulative score based on the different sets of actions 110 produced by AI agent 108 as scored by reward module 112. Actions 116 may include things such as clicking links on a website, filling in text fields on a website, performing a mechanical action on a robotic arm, adjusting a parameter of a mechanical system, etc.

In some embodiments, an AI agent 108 may generate alternative actions instead of following the recommendations of prompt 106. To address this, the logits corresponding to tokens associated with the actions may be directly modified, ensuring that the intended actions are consistently chosen. The UCB score described above may be further modified in order to use the modified score to modify the logits for a given query. In order to modify the logit associated with each action, each step in a set of actions may be determined by a separate prompt. The UCB score equation may be modified to provide instead a UCL (UCB for Logits) score. This score may be used to update the loglikelihoods of tokens corresponding to all possible actions for the current state in the language model of AI agent 108. By updating the loglikelihoods using the UCL scores, the language model is forced to execute high-reward actions. The UCL score may be determined as follows:

$$UCL ( s , a ) = B * ln \frac{UCB ( s , a )}{K}$$

where UCB is computed as described above, and the constants B and K control the extent to which logits of the language model of AI agent 108 are offset.

FIG. 2A is a simplified diagram illustrating a Monte-Carlo Tree Search framework according to some embodiments. Circles in the diagrams represent nodes in the MCTS tree, with bolded circles being those being used in a certain attempt at finding a solution to the task prompt. The main steps of the MCTS algorithm can be summarized as follows: (1) Selection 262: Starting from the root of the search tree, the algorithm traverses down the tree by selecting actions that balance exploration and exploitation. It uses a selection policy, such as the Upper Confidence Bound, to determine the most promising nodes; (2) Expansion 264: Once a leaf node is reached, the algorithm expands the tree by randomly picking a node from a set of possible child nodes; (3) Simulation 266: MCTS performs Monte Carlo simulations (also known as rollouts) from newly expanded node. These simulations play out random sequences of actions until reaching a terminal state, yielding an outcome or reward; (4) Backpropagation 268: After a simulation is completed, the result is backpropagated up the tree. The statistics of the visited nodes, such as the number of visits and accumulated rewards, are updated accordingly. These four steps are repeated iteratively for a specified number of iterations or until a time limit is reached. As more iterations are performed, the search tree evolves and provides increasingly accurate estimates of the value of different actions.

FIG. 2B is a simplified diagram illustrating a Monte-Carlo Tree Search framework according to some embodiments. In the illustrated embodiment, the selection, expansion, and simulation steps are aggregated into a single step, which is performed by the LLM generating a full sequence of actions in response to a single prompt, as discussed further herein at least with respect to FIG. 1. Rather than progressing step by step from the initial state, taking actions, and moving to the next state until reaching a terminal state, the MCTS may employ the a UCB score as its selection policy.

FIG. 2C is a simplified diagram illustrating a Monte-Carlo Tree Search framework according to some embodiments. In some embodiments in which a “UCL” score is used, as described herein, the selection and expansion steps may be aggregated into a single step, but with the adjustments to logits of the LLM, all the steps may not simultaneously be generated. Instead, each step may be generated individually so that control of the logits may be performed at the generation of each individual action as described herein at least with respect to FIG. 1.

FIG. 2D is a simplified diagram 200 illustrating tree searching within an AI agent framework according to some embodiments. For a given environment, an initial state 201 (i.e., state 0) presents a number of options, illustrated here as actions 1-4. This may represent, for example, four different links in a website. Depending on which action is selected at state 201, the subsequent state (i.e., state 1) may include different action options such as illustrated in states 202-205. Illustrated here are further subsequent states 206-211 which represent different paths which might be taken depending on the actions selected at each state. This naturally produces a tree structure, with each state having potentially more states branching off depending on the action selected. Such a tree structure with associated actions may be stored in memory, for example by tree search module 104.

Each action illustrated in FIG. 2D may have a score associated with it as described in FIG. 1. In some embodiments, scores may be individual to each action including the path taken to reach the action. In some embodiments, actions may have a score which is related only to the action and not the specific state. In other embodiments, scores may be specific to an action for a specific state level (e.g., state 2). For example, Action 1 may have a score associated with it at state 2, regardless of which path was taken to reach state 2. The tree structure may not be known by the system a priori, but may be discovered as AI agent 108 explores environment 118. Even when a known set of possible actions exist, the tree structure may only include in memory those actions which have been previously attempted and therefore have a score associated with them. In some embodiments, a tree structure may be initialized with initial scores for known actions.

FIG. 3 is a simplified diagram 300 illustrating an AI agent framework according to some embodiments. As described in FIGS. 1-2, AI agent 108 iteratively generates actions 110, those actions are used to determine updated scores associated with each action, those scores inform subsequent prompts of the AI agent 108 to further refine the actions 110. Illustrated in FIG. 3 are three “passes,” each representing an iteration of this process. As illustrate, during pass 1, the environment is observed as environment 301 which in this example is a webpage with four links. The AI agent is prompted to determine an action sequence 304 for some target task (e.g., target task 102). The AI agent generates a list of actions which here includes clicking link 1, then clicking link 2. The system implementing the framework determines whether or not this sequence of actions is successful, and assigns scores to each of the attempted actions accordingly as described in FIGS. 1-2. These scores inform the next pass. In pass 2, the web page is initialized as in pass 1, but the prompt in this pass further includes prompt engineering 305 which includes indications of relative scores of each action.

As illustrated, the numeric scores may be converted into text indications such as “high” or “low” as those may be more suited as inputs to the AI agent. The mapping of numeric scores to text indications may be based on a rule or heuristic. For example, at each step, only the action with the highest score may be indicated as “high” and the remaining actions may be indicated as “low.” In the case of two scores having the same highest scores for a particular step, both of those actions may be indicated as “high.” In the case where two actions are “high” for a given step, the AI agent may select either of those actions. In this example, prompt engineering 305 indicates link 1 has a low score at step 1, link 2 has a high score at step 1, link 3 has a low score at step 2, and link 4 has a high score at step 2. Based on this prompt, the AI agent is more likely to select the actions indicated as having a high score, such as illustrated here in action sequence 307 which includes link 2 at step 1 and link 4 at step 2. The system determines whether the action sequence 307 was successful and updates the action scores accordingly.

In pass 3, the web page is initialized as in passes 1 and 2, but the prompt in this pass further includes prompt engineering 306 which builds on prompt engineering 305 with scores updated based on pass 2. In this example, prompt engineering 306 indicates links 1 and 2 have low scores at step 1, link 3 has a high score at step 1, links 3 and 4 have low scores at step 2, and link 2 has a high score at step 2. Based on this prompt, the AI agent is more likely to select the actions indicated as having a high score, such as illustrated here in action sequence 308 which includes link 3 at step 1 and link 2 at step 2. Note that link 2 has a different relative reward score depending on the step, which means each of those values is stored independently in memory associated with the respective step. The system determines whether the action sequence 308 was successful and updates the action scores accordingly. Additional passes may be performed which are not illustrated. If the predetermined number of iterations has occurred and/or a successful pass occurred, then the system may execute the successful action sequence. If there is more than one successful action sequence, the sequence with the highest cumulative score (e.g., the sum of the scores of each action in the sequence) may be selected to be executed.

Embodiments described herein include a number of different methods which fit within this framework. One embodiment is a “UCB driven Chain-of-Thoughts” (UCB-CoT) approach. In UCB-CoT, rewards are assigned to actions based on the correctness of the generated solutions at the end of each pass. The rewards are determined using a UCB calculation as described above. In another embodiment, a “simple-Reward driven Chain-of-Thoughts” (R-CoT) may be used which instead of a UCB score utilizes a simpler reward function. For example, R-CoT may utilize a simple +1 reward to each action for successful sequences, and a simple −1 reward to each action for failed sequences. In another embodiment, a “Multi-pass CoT” may be utilized where a UCB or UCL type score may be utilized, over multiple passes as described in FIGS. 1-3.

UCB type scores allow the framework to strike a balance between exploration and exploitation of the search space. Encouraging the model to pick a HIGH reward action based on UCB score helps the model to solve the given problem. The R-CoT approach involves providing the model with specific information and instructions to solve a problem during each pass. The prompt may include details about the problem, instructions, action space, and three examples of solved problems (3-shot examples). Additionally, feedback from previous passes is given to the model in each pass. In the Simple-Reward® setting, if the action sequence leads to the correct answer, a ‘HIGH’ reward is assigned to each action or step in the solution. Conversely, if the action sequence does not lead to the correct answer, a ‘LOW’ reward is assigned. This reward information is included in the prompt for the subsequent pass. Unless the action sequence results in a correct answer, none of the actions or steps will receive a ‘HIGH’ reward. Consequently, the model is encouraged to propose new actions in order to improve its performance.

Similar to the R-CoT approach, the UCB-CoT prompt incorporates comprehensive information about the problem, including problem details, instructions, action space, and three examples of solved problems (referred to as 3-shot examples). Moreover, feedback from previous passes is incorporated into the model at each pass. In line with the methodology described above, the Upper Confidence Bound (UCB) score is computed for each action within the solution during each pass. Subsequently, the action associated with the highest UCB score is associated with a ‘HIGH’ reward, while the remaining actions are designated as ‘LOW’ reward. This UCB scoring mechanism ensures an effective selection process, by striking a good balance between exploration and exploitation, for identifying the most promising action to be executed, optimizing the model's performance within the UCB-CoT framework.

### Computer and Network Environment

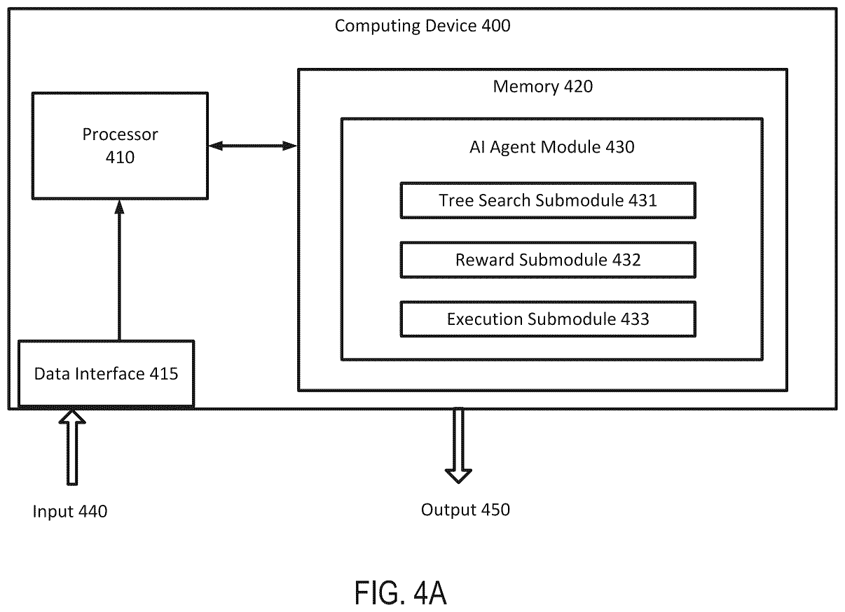

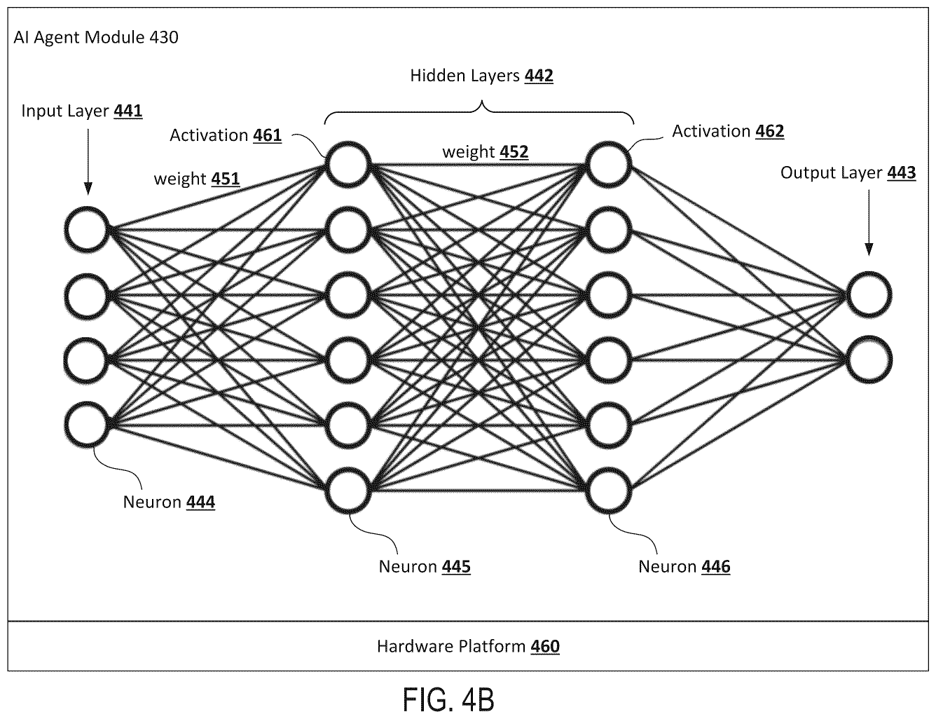

FIG. 4A is a simplified diagram illustrating a computing device implementing the AI agent framework described in FIGS. 1-3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for AI agent module 430 that may be used to implement and/or emulate the systems and models, and/or to implement any of the methods described further herein. AI agent module 430 may receive input 440 such as an input training data (e.g., task prompts, known-good action sequences, or known-good results of a correct action sequence) via the data interface 415 and generate an output 450 which may be a sequence of actions or the execution of those actions.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as target tasks, from a user via the user interface.

In some embodiments, the AI agent module 430 is configured to determine actions based on a target task. AI agent module 430 may further include a tree search submodule 431 (e.g., similar to tree search module 104 in FIG. 1). Tree search submodule 431 may be configured to maintain reward scores for each action in a set of actions. AI agent module 430 may further include a tree search submodule 431 (e.g., similar to tree search module 104 in FIG. 1). Tree search submodule 431 may be configured to maintain reward scores for each action in a set of actions. AI agent module 430 may further include a reward submodule 432 (e.g., similar to tree search module 104 in FIG. 1). Reward submodule 432 may be configured to determine reward scores for actions based on performance of the determined sequence of actions (e.g., similar to reward module 112 in FIG. 1). AI agent module 430 may further include an execution submodule 433. Execution submodule 432 may be configured to cause selected actions to be performed on an environment (e.g., environment 118 in FIG. 1).

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing the AI agent module 430 described in FIG. 4A, according to some embodiments. In some embodiments, the AI agent module 430 and/or one or more of its submodules 431-433 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as prompts. The number of nodes (neurons) in the input layer 441 may be determined by the dimensionality of the input data (e.g., the length of a vector of text). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the AI agent module 430 receives an input 440 of a target task and transforms the input into an output 450 of a sequence of actions. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent module 430 and/or one or more of its submodules 431-433 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a large language model, and/or the like.

In one embodiment, the AI agent module 430 and its submodules 431-433 may be implemented by hardware, software and/or a combination thereof. For example, the AI agent module 430 and its submodules 431-433 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based AI agent module 430 and one or more of its submodules 431-433 may be trained by iteratively updating the underlying parameters (e.g., weights 451, 452, etc., bias parameters and/or coefficients in the activation functions 461, 462 associated with neurons) of the neural network based on a loss objective. For example, during forward propagation, the training data such as target task prompts and associated actions are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding ground truth sequence of actions) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as new tasks.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in AI agents.

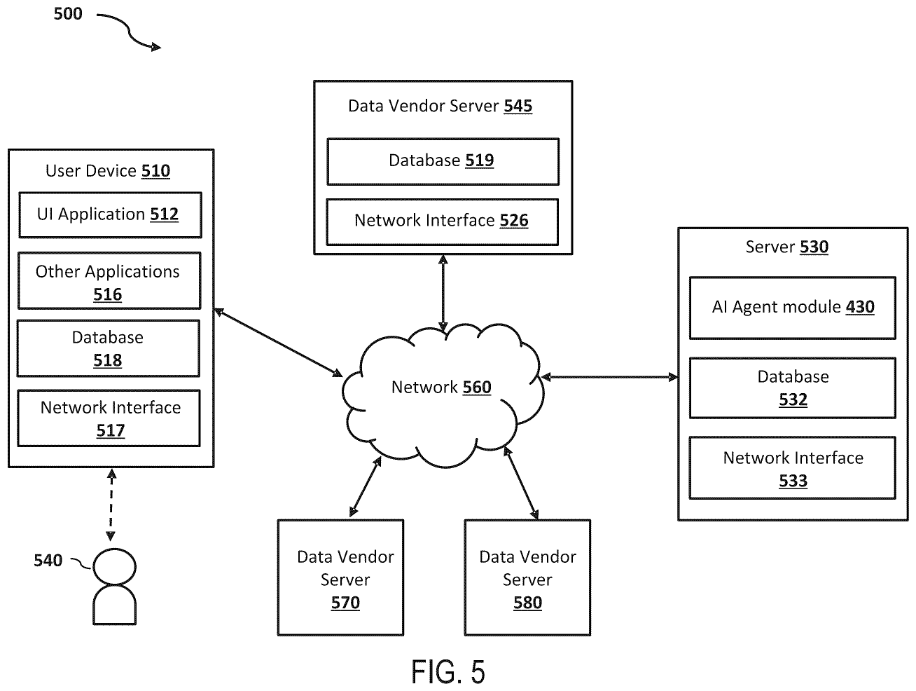

FIG. 5 is a simplified block diagram of a networked system 500 suitable for implementing the AI agent framework described in FIGS. 1-3 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating a sequence of actions and/or the results of executing actions on an environment from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view provided data.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including task prompts and action sequences to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the AI agent module 430 and its submodules described in FIG. 4A. In some implementations, AI agent module 430 may receive data from database 519 at the data vendor server 545 via the network 560 to generate action sequences and/or results of executing actions on an environment. The generated actions may also be sent to the user device 510 for execution and/or review by the user 540 via the network 560.

In some embodiments, at least one or more of data vendor servers 545, 470 and 580 may host one or more LLM models that are external to server 530. Therefore, AI agent module 430 may employ one or more external LLM models located on an external servers, e.g., via an API. For example, external LLM may comprise commercially available LLM services such as but not limited to GPT-3, GPT-4, and/or the like.

The database 532 may be stored in a transitory and/or non-transitory memory of the server 530. In one implementation, the database 532 may store data obtained from the data vendor server 545. In one implementation, the database 532 may store parameters of the AI agent module 430. In one implementation, the database 532 may store previously generated actions, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

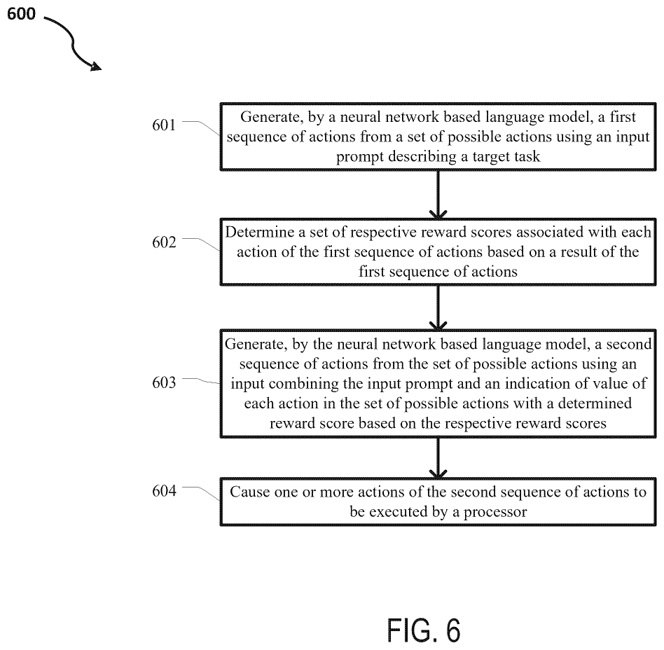

FIG. 6 is an example logic flow diagram illustrating a method of predicting a sequence of actions by a neural network based language model based on the framework shown in FIGS. 1-3, according to some embodiments. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the AI agent module 430 (e.g., FIGS. 4A and 5) that performs action predictions.

As illustrated, the method 600 includes a number of enumerated steps, but aspects of the method 600 may include additional steps before, after, and in between the enumerated steps. In some aspects, one or more of the enumerated steps may be omitted or performed in a different order.

At step 601, a system (e.g., user device 510, server 530, or computing device 400) generates, by a neural network based language model (e.g., AI agent 108), a first sequence of actions (e.g., actions 110 or action sequence 304, 307, or 308) from a set of possible actions using an input prompt describing a target task (e.g., target task 102).

At step 602, the system determines a set of respective reward scores (e.g., rewards 114) associated with each action of the first sequence of actions based on a result of the first sequence of actions. In some embodiments, the first sequence of actions is generated as a single output of the neural network based language model. For example, a single prompt may cause the language model to generate a full sequence of actions. In some embodiments, the results of the first sequence of actions is a predicted results determined by the neural network based language model. For example, the language model may be prompted to determine whether the sequence of actions it generated would be successful if executed on the environment (e.g., environment 118). In other embodiments, the results are determined based on executing the generated actions on a simulated or actual environment.

At step 603, the system generates, by the neural network based language model, a second sequence of actions (e.g., actions 110 or action sequence 304, 307, or 308) from the set of possible actions using an input combining the input prompt and an indication of value of each action in the set of possible actions with a determined reward score based on the respective reward scores. In some embodiments, the indication of value of each action includes a non-numeric description. For example, the indication may include the text “high” or “low”. In some embodiments, the respective reward scores are based on a number of times a respective action was included in a prior sequence of actions (e.g., as in UCB or UCL score calculations). In some embodiments, the indication of value of each action is associated with each step in the first sequence of actions. For example, as illustrated in FIG. 3, the reward indications may be specific to an action at a certain step. In some embodiments, the indication of value of each action includes a positive indication for only actions with a highest respective reward score.

At step 604, the system causes one or more actions of the second sequence of actions to be executed by a processor (e.g., processor 410).

### Example Results

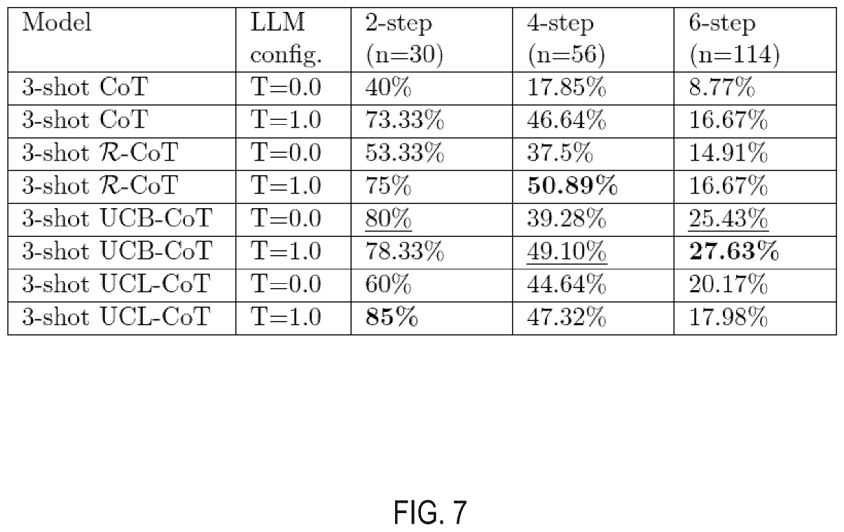

FIGS. 7-10 represent exemplary test results using embodiments described herein. As a baseline for comparison, a single-pass “chain of thought” (CoT) technique was used. The single-pass CoT technique utilized prompts which include a series of step-by-step examples, ultimately leading to a final solution. The language model is queried only once (single-pass) to solve the given problem. If the solution provided by the language model was accurate, it was deemed successful. A Multi-pass CoT technique was compared to the baseline and other implementations. The multi-pass CoT technique builds upon the single-pass CoT by extending the number of queries to the language model. Instead of querying the language model only once, it is queried multiple times. A successful outcome is achieved if at least one of the queries yields a correct answer. Another model used is “reasoning via planning” (RAP) as described in Hao et al., Reasoning with language model is planning with world model, arXiv:2305.14992, 2023. The RAP framework leverages language models to strategically plan and execute coherent reasoning processes for a wide range of tasks. By repurposing the language model and constructing a world model through prompting, the framework enables the language model to anticipate future outcomes and make informed decisions.

One of the datasets used in the experiments was the “Blocksworld” dataset as described in Valmeekam et al., On the planning abilities of large language models (a critical investigation with a proposed benchmark), arXiv:2302.06706, 2023. The Blocksworld dataset represents a planning problem that involves the arrangement of blocks with varying colors in a predetermined configuration and the desired final configuration. The term “block configuration” refers to the specific arrangement of the blocks, where each block can be positioned either on top of another block, on a table surface, or held in hand, but not all options are available simultaneously. The blocks are uniquely identified by their respective colors, such as red, blue, and so on.

Another dataset used in experiments was the GSM8K dataset as described in Cobbe et al., Training verifiers to solve math word problems, arXiv:2110.14168, 2021. The GSM8K dataset comprises a collection of 8.5K grade school math word problems of exceptional quality. Each problem within this dataset typically requires a solution involving a sequence of elementary calculations, utilizing fundamental arithmetic operations such as addition, subtraction, multiplication, and division (+, −, ×, ÷). The number of steps required to solve each problem falls within the range of 2 to 8 steps. While the problems exhibit a high level of diversity, the solutions rely solely on elementary concepts, making achieving high test performance an achievable objective.

In order to assess the efficacy of the proposed algorithm more accurately, it is advisable to compare the performance of the different algorithms when the temperature (T) is set to 0.0. Setting a higher temperature value can obscure the impact of the proposed approaches, making it difficult to evaluate their effectiveness. Unless indicated otherwise in the illustrated results, the temperature (T) of the models was set to 0.0.

FIG. 7 illustrates the performance of different embodiments described herein on the Blocksworld dataset. Each experiment is run for 10 iterations/passes and chatGPT (model: gpt-3.5-turbo) is used for all the experiments. The Blocksworld dataset is divided into 3 subcategories (2, 4, 6 steps) based on the number of steps required to transform the block configuration from initial to final. Let ‘n’ denote the number of instances in each of these sub-categories. To transform the block configuration from initial to final, the model is expected to propose sequence of steps/actions. In Blocksworld, there are only four major actions-Stack, Unstack, Pick and Put. FIG. 7 illustrates the performance of different variants of the Chain of Thoughts (CoT) algorithm. The best score is in bold and the second best score is underlined.

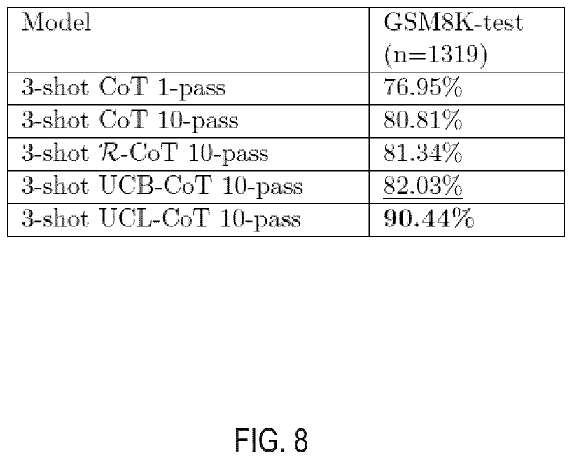

FIG. 8 illustrates the performance of different embodiments described herein on the GSM8K dataset. As illustrated, the best results were observed with a 3-shot (i.e., e examples provided in the prompt) UCL-COT embodiment utilizing 10 passes.

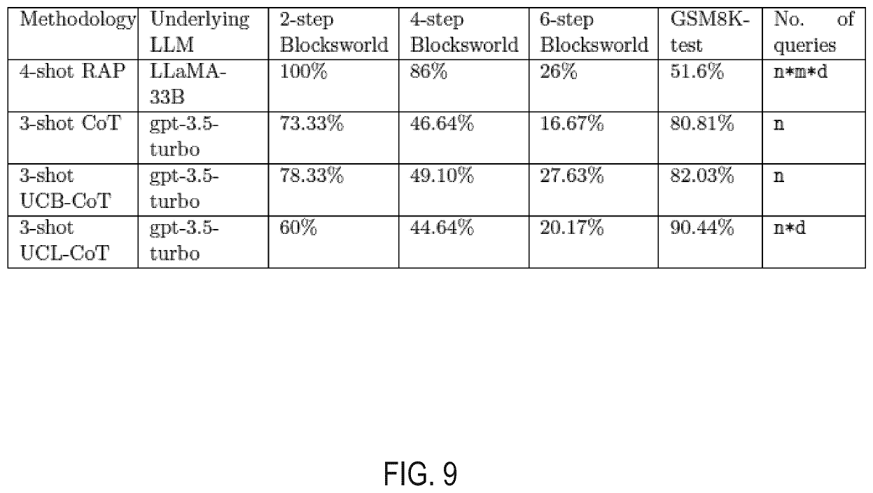

From the results in FIGS. 8-9, it is shown that UCB based feedback outperforms simple reward based feedback in Planning (Blocksworld, 2-& 6-step setup) and Mathematical Reasoning (GSM8K) datasets.

FIG. 9 illustrates a comparison between embodiments described herein and another Monte Carlo Tree Search (MCTS) based model, namely RAP as described in Hao et al., Reasoning with language model is planning with world model, arXiv:2305.14992, 2023. The table presents a detailed analysis of various performance metrics and highlights the distinguishing features and advantages of embodiments of the framework described herein in comparison to RAP. Three variables were utilized, specifically: n, which denotes the number of iterations or passes, d, representing the depth limit, and m, indicating the number of possible actions generated at each state. FIG. 9 provides a detailed comparison of the query count between the LLM/Agent for RAP, vanilla CoT and UCB-CoT & UCL-CoT. The results clearly demonstrate the significant speed advantage of UCB-CoT over RAP. The framework described herein not only outperforms RAP in terms of computational efficiency but also offers enhanced flexibility. Notably, UCB-CoT can be seamlessly implemented using any Large Language Model (LLM), including popular APIs like OpenAI, even in scenarios where access to the underlying logits is restricted. This versatility makes UCB-CoT a highly adaptable and practical choice for a wide range of applications.

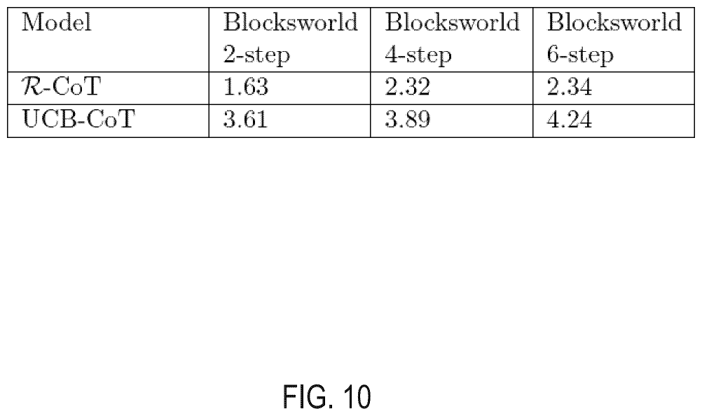

FIG. 10 illustrates the average number of unique actions per step in the solution. The results as illustrated reveal that the UCB-CoT approach promotes a greater degree of action exploration at each step compared to the R-CoT method. This emphasis on exploration within the action space may facilitate the model in discovering novel trajectories for problem-solving, ultimately leading to an increased success rate. By encouraging the model to explore alternative actions, UCB-CoT expands the scope of potential solutions and enhances the model's ability to overcome challenges effectively.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of predicting a sequence of actions to complete a target task by a neural network based language model, the method comprising:
generating, by the neural network based language model, a first sequence of actions from a set of possible actions using an input prompt describing a target task;
determining a set of respective reward scores associated with each action of the first sequence of actions based on a result of the first sequence of actions;
generating, by the neural network based language model, a second sequence of actions from the set of possible actions using an input combining the input prompt and an indication of value of each action in the set of possible actions with a determined reward score based on the respective reward scores; and
causing one or more actions of the second sequence of actions to be executed by a processor.

2. The method of claim 1, further comprising:
generating the indication of value by mapping a numeric score to a non-numeric description.

3. The method of claim 1, wherein the respective reward scores are computed based on a number of times a respective action was included in a prior sequence of actions towards executing the target task.

4. The method of claim 1, wherein the indication of value of each action includes a positive indication only for actions with a highest respective reward score.

5. The method of claim 1, wherein the first sequence of actions is generated at one inference instance of the neural network based language model in response to the input prompt.

6. The method of claim 1, wherein the result of the first sequence of actions is a predicted result determined by the neural network based language model.

7. The method of claim 6, further comprising:
generating, by the neural network based language model, the predicted result based on a prompt including the first sequence of actions and a predefined prompt requesting a prediction.

8. A system for predicting a sequence of actions to complete a target task, the system comprising:
a memory that stores a neural network based language model and a plurality of processor-executable instructions;
a communication interface that receives an input prompt describing a target task; and
one or more hardware processors that read and execute the plurality of processor-executable instructions from the memory to perform operations comprising:
generating, by the neural network based language model, a first sequence of actions from a set of possible actions using the input prompt describing the target task;
determining a set of respective reward scores associated with each action of the first sequence of actions based on a result of the first sequence of actions;
generating, by the neural network based language model, a second sequence of actions from the set of possible actions using an input combining the input prompt and an indication of value of each action in the set of possible actions with a determined reward score based on the respective reward scores; and
causing one or more actions of the second sequence of actions to be executed by a processor.

9. The system of claim 8, the operations further comprising:
generating the indication of value by mapping a numeric score to a non-numeric description.

10. The system of claim 8, wherein the respective reward scores are computed based on a number of times a respective action was included in a prior sequence of actions towards executing the target task.

11. The system of claim 8, wherein the indication of value of each action includes a positive indication only for actions with a highest respective reward score.

12. The system of claim 8, wherein the first sequence of actions is generated at one inference instance of the neural network based language model in response to the input prompt.

13. The system of claim 8, wherein the result of the first sequence of actions is a predicted result determined by the neural network based language model.

14. The system of claim 13, the operations further comprising:
generating, by the neural network based language model, the predicted result based on a prompt including the first sequence of actions and a predefined prompt requesting a prediction.

15. A non-transitory machine-readable medium comprising a plurality of machine-executable instructions which, when executed by one or more processors, are adapted to cause the one or more processors to perform operations comprising:
generating, by a neural network based language model, a first sequence of actions from a set of possible actions using an input prompt describing a target task;
determining a set of respective reward scores associated with each action of the first sequence of actions based on a result of the first sequence of actions;
generating, by the neural network based language model, a second sequence of actions from the set of possible actions using an input combining the input prompt and an indication of value of each action in the set of possible actions with a determined reward score based on the respective reward scores; and
causing one or more actions of the second sequence of actions to be executed by a processor.

16. The non-transitory machine-readable medium of claim 15, the operations further comprising:
generating the indication of value by mapping a numeric score to a non-numeric description.

17. The non-transitory machine-readable medium of claim 15, wherein the respective reward scores are computed based on a number of times a respective action was included in a prior sequence of actions towards executing the target task.

18. The non-transitory machine-readable medium of claim 15, wherein the indication of value of each action includes a positive indication only for actions with a highest respective reward score.

19. The non-transitory machine-readable medium of claim 15, wherein the first sequence of actions is generated at one inference instance of the neural network based language model in response to the input prompt.

20. The non-transitory machine-readable medium of claim 15, wherein the result of the first sequence of actions is a predicted result determined by the neural network based language model.
